(19) United States
(12) Patent Application Publication
(10) Pub. No.: US 2011/0298832 A1
(43) Pub. Date: Dec. 8, 2011

(54) COLOR SEQUENTIAL DISPLAY AND LIGHT SOURCE CONTROL METHOD THEREOF

(75) Inventors: Chia-Cheng Lai, Tainan County (TW); Ming-Cheng Chiu, Tainan County (TW)

(73) Assignee: HIMAX DISPLAY, INC., Tainan County (TW)

(21) Appl. No.: 12/792,026

(22) Filed: Jun. 2, 2010

(51) Int. Cl. G09G 5/10; G09G 3/36

(52) U.S. Cl. 345/690; 345/88

(57) ABSTRACT

A color sequential display and a light source control method of the color sequential display are provided. The light source control method includes the following steps. A frame data of a frame period is received, wherein the frame period includes a plurality of color sub-frame periods. The frame data is analyses to obtain gray distributions of a plurality of colors in the frame data. Whether all or a portion of a plurality of color light sources of the color sequential display are turned on in the frame period is determined according to the gray distributions of the colors. Wherein, a light emitting time of the turned on color light source is longer than any one of the color sub-frame periods. Therefore, the brightness displayed by the color sequential display can be enhanced.

### BACKGROUND

1. Field of the Invention

The present invention relates to a display device. More particularly, the present invention relates to a color sequential display and a light source control method thereof.

2. Description of Related Art

Compared to a color mixing performed on a spatial domain, a color sequential display mixes colors of three primary colors (red, green and blue) on a time domain. For example, a color sequential projector, a color sequential liquid crystal display (LCD), etc. are all color sequential displays. A projection apparatus can project images onto a large screen to facilitate more people watching content displayed on the screen at the same time. Therefore, the projection apparatus is widely used in public places such as companies, schools, etc. Moreover, as family-used display products trend to be large-scaled, the projection apparatus is also widely used in general families, and becomes a commonly used electronic product in people's daily life.

With development of technology, electronic products are developed to have high speed, high performance, and design features of lightness, slimness, shortness and smallness. In this case, a pico projector (a mini projector) gradually becomes a main stream in the market of personal digital products. Generally, a light source of the pico projector applies a light emitting diode (LED) or other solid state light sources to improve a total lumen thereof, so as to improve a brightness of projected images. After the pico projector is produced, a size of the pico projector including a battery is similar to a size of a general mobile phone in the market. Even, the pico projector can be integrated in the mobile phone. Therefore, it has advantages of portability and no restriction of usage locations.

However, in the conventional technology, when the color sequential method is used to display a color image, a light source module of the pico projector can respectively provide light sources corresponding to the three primary colors (i.e. red, blue and green) during three color sub-frame periods. Namely, at a same time, only the light source of one color can emit light, and the light sources of the other colors are turned off. For example, during a red color sub-frame period, only a red light source is turned on to emit light, and a blue light source and a green light source are turned off during the red color sub-frame period. In case that the whole frame has a single pure color, an intensity of the light source can be weakened by time division, so that utilization of the pico projector is probably limited by an environmental light intensity.

FIG. 1A is a driving waveform diagram of a conventional color sequential display. Referring to FIG. 1A, the conventional color sequential display can respectively provide a red light source, a green light source and a blue light source during a red color sub-frame period P_{R}, a green color sub-frame period P_{G} and a blue color sub-frame period P_{B} of a frame period P_{F}. Moreover, during the red color sub-frame period P_{R}, the green color sub-frame period P_{G} and the blue color sub-frame period P_{B}, liquid crystals are transparent or opaque relative to a display data, so that the red light, the green light and the blue light can display a gray level of the image.

Taking a situation that the whole frame is a red frame as an example, FIG. 1B is a driving waveform diagram of a conventional color sequential display displaying a red frame. Referring to FIG. 1B, when the red frame is displayed, the liquid crystals are transparent only during the red color sub-frame period P_{R}, so that the red light can display the gray level of the image. The liquid crystals are transited to be opaque during the green color sub-frame period P_{G} and the blue color sub-frame period P_{B}, so as to respectively shield the color lights emitted from the green light source and the blue light source. Now, during the whole frame period P_{F}, the red frame is only displayed during the red color sub-frame period P_{R}, i.e. an actual display time of the red frame is equal to (even smaller than) one third of the frame period P_{F}, so that a brightness of the red frame is greatly reduced, which may influence a visibility of the red frame.

### SUMMARY

The invention is directed to a color sequential display and a light source control method thereof, which can increase a light emitting time of a color light source to increase a brightness of a single color frame displayed by the color sequential display.

The invention is directed to a light source control method of a color sequential display, the light source control method includes the following steps. A frame data of a frame period is received, wherein the frame period includes a plurality of color sub-frame periods. The frame data is analysed to obtain gray distributions of a plurality of colors in the frame data. Whether all of or a portion of a plurality of color light sources of the color sequential display are turned on during the frame period is determined according to the gray distributions of the colors. Wherein, a light emitting time of the turned on color light source is longer than any one of the color sub-frame periods.

The invention also provides a color sequential display including a display panel, a light source module and a control module. The light source module provides a plurality of color light sources to the display panel. The control module receives a frame data of a frame period, and analyses the frame data to obtain gray distributions of a plurality of colors in the frame data. The control module determines whether or not to turn on all of or a portion of the color light sources during the frame period according to the gray distributions of the colors. Wherein, the frame period includes a plurality of color sub-frame periods, and a light emitting time of the turned on color light source is longer than any one of the color sub-frame periods.

According to the above descriptions, in the color sequential display and the light source control method thereof, according to the gray distributions of the colors, when the obtained frame data is a pure color frame, the color light sources that are less used or not used are turned off, and the color light sources corresponding to the pure color frame are turned on. Wherein, the light emitting time of the turned on color light source is longer than one of the color sub-frame periods. In this way, the light emitting time of the color light source can be increased to increase a maximum brightness of the light source module. In some exemplary embodiments, light leakage can be avoided by turning off the color light sources that are not used, so as to increase a color purity of the frame.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a driving waveform diagram of a conventional color sequential display.

FIG. 1B is a driving waveform diagram of a conventional color sequential display displaying a red frame.

FIG. 2A is a system schematic diagram illustrating a color sequential display according to an exemplary embodiment of the invention.

FIG. 2B is a system schematic diagram illustrating a control module of FIG. 2A.

FIGS. 3A-3H are driving waveform diagrams of different pure color frames according to an exemplary embodiment of the invention.

FIG. 4 is a flowchart illustrating a light source control method according to an exemplary embodiment of the invention.

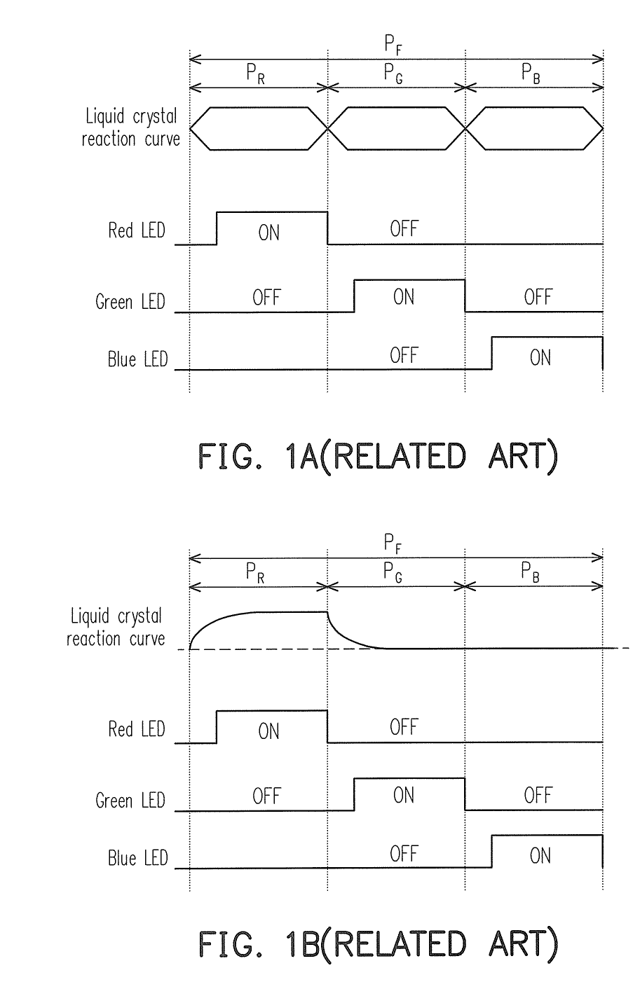

### DETAILED DESCRIPTION OF DISCLOSED EMBODIMENTS

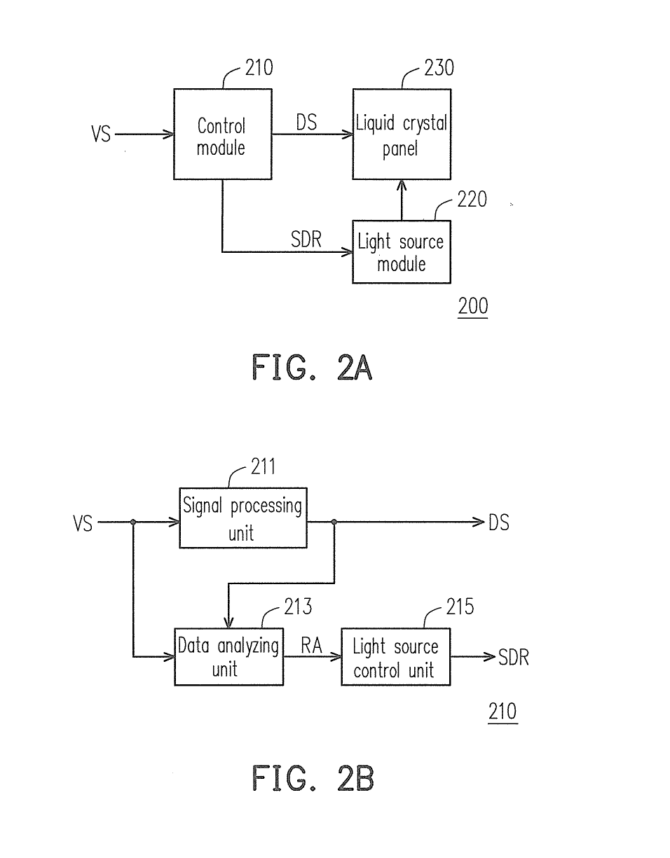

FIG. 2A is a system schematic diagram illustrating a color sequential display according to an exemplary embodiment of the invention. Referring to FIG. 2A, the color sequential display (for example, a projector 200) includes a control module 210, a light source module 220 and a liquid crystal panel 230, wherein the liquid crystal panel 230 can be a liquid crystal on silicon (LCOS) panel, and the projector 200 can be a pico projector. The control module 210 receives a video signal VS, and generates display data DS to the liquid crystal panel 230 and generates driving signals SDR to the light source module 220 according to a frame data transmitted by the video signal VS. The liquid crystal panel 230 alternately displays sub frames corresponding to different colors according to the display data DS, and the light source module 220 synchronously provides corresponding color lights to the liquid crystal panel 230 according to the driving signals SDR. The liquid crystal panel 230 projects the lights onto an object (for example, a screen or a wall) by reflecting/transmitting the light sources provided by the light source module 220, so as display an image.

In the present exemplary embodiment, the liquid crystal panel 230 is, for example, a color sequential LCOS (CS-LCOS), so that color filters are not formed on the liquid crystal panel 230. Moreover, the projector 200 can mix colors on a time domain according to a color sequential method, so as to display color images. Now, the light source module 220 can correspondingly provide different color light sources (for example, a red light, a blue light and a green light) at different time during a frame period P_{F}. Wherein, the red light, the blue light and the green light can be provided by light-emitting diodes (LEDs) of corresponding colors. Namely a red LED, a blue LED and a green LED can serve as the red light source, the blue light source and the green light source.

FIG. 2B is a system schematic diagram illustrating the control module 210 of FIG. 2A. Referring to FIG. 2A and FIG. 2B, the control module 210 includes a signal processing unit 211, a data analysing unit 213 and a light source control unit 215. The signal processing unit 211 receives the frame data transmitted by the video signal VS, and generates the display data DS according to the video signal VS. The signal processing unit 211 can generate the display data DS according to an image simulation technique, wherein the image simulation technique is, for example, a frame rate control method or a pixel dithering method. The data analysing unit 213 receives the display data DS and the frame data transmitted by the video signal VS, and analyses a frame to be displayed according to the frame data and the display data DS, so as to generate an analysing result RA.

The light source control unit 215 generates the driving signals SDR according to the analysing result RA, and the light source control unit 215 can provide a corresponding number of the driving signals SDR according to a number of the color light sources provided by the light source module 220. In other words, if the light source module 220 provides the red light, the blue light and the green light, the light source control unit 216 correspondingly generates three driving signals SDR, so as to respectively control the red LED, the blue LED and the green LED to emit light.

Further, when the data analysing unit 213 receives the display data DS and a frame data of one frame period, the data analysing unit 213 performs analysing to obtain gray distributions of the three primary colors (i.e. red, blue and green) to serve as the analysing result RA. In case that the whole frame has a single color, when a gray average value of the gray distribution of one of the three primary colors is smaller than or equal to a threshold value, it represents that the frame almost does not contain such color component, so that the light source control unit 215 can turn off the color light source of such color when such frame is displayed (within the corresponding frame period). Conversely, when the gray average value of the gray distribution of such color is greater than the threshold value, the light source control unit 215 correspondingly turns on the color light source of such color.

For example, when a gray average value of the gray distribution of the red color in the three primary colors is smaller than or equal to the threshold value, it represents that the frame almost does not contain the red component, so that the light source control unit 215 turns off the red light source during the frame period P_{F}. Conversely, when the gray average value of the gray distribution of the red color is greater than the threshold value, the light source control unit 215 correspondingly turns on the red light source. Wherein, the threshold value is generally a relatively low gray value (for example, a gray value of 15), though the threshold value can be different according to different circuit designs and different usage habits, which is not limited by the invention.

Moreover, besides determining whether or not to turn off the corresponding color light sources according to the gray average values of the colors, the light source control unit 215 can also determine whether or not to turn off the corresponding color light sources according to whether gray distribution ranges of the colors fall within a threshold range. In other words, when a gray distribution range of a certain color falls within the threshold range, the light source control unit 215 turns off the color light source of such color. Conversely, when the gray distribution range of such color exceeds the threshold range, the light source control unit 215 turns on the light source of such color.

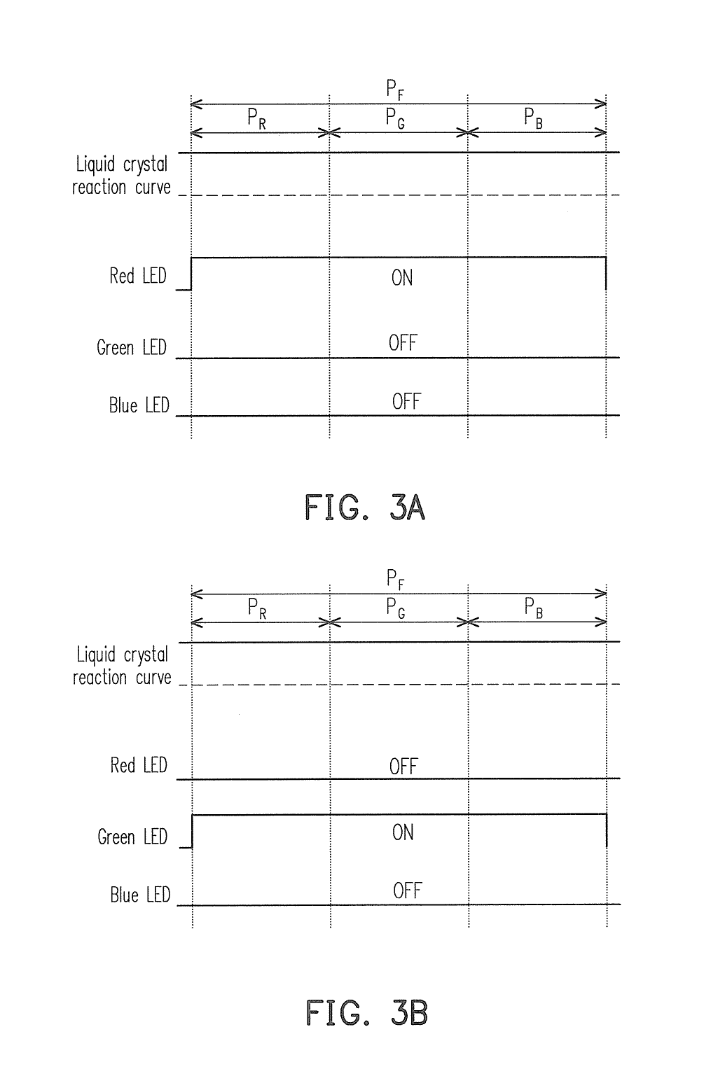

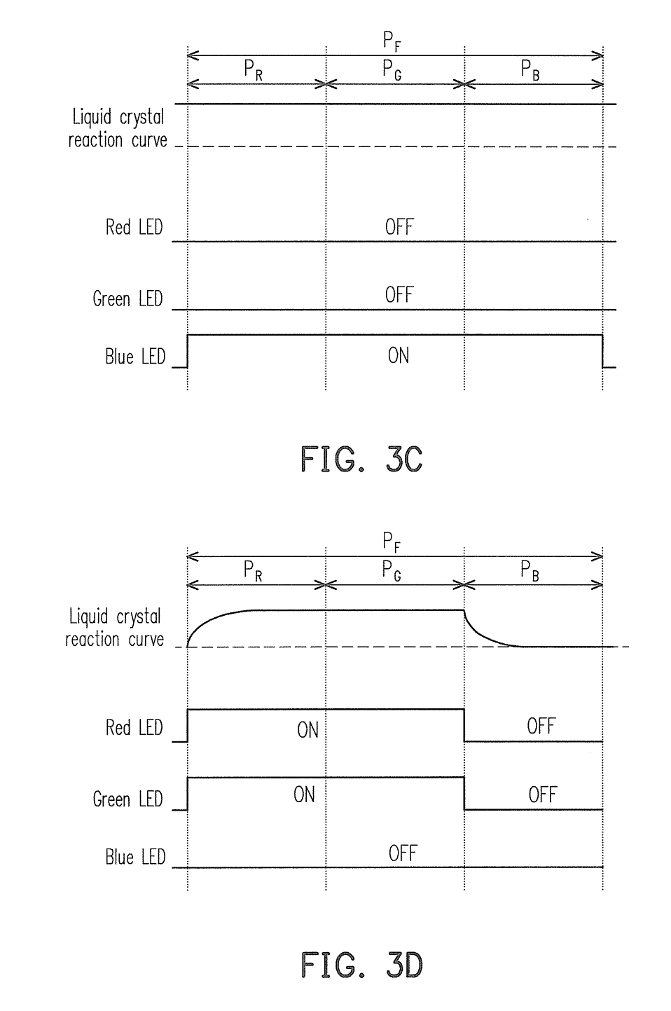

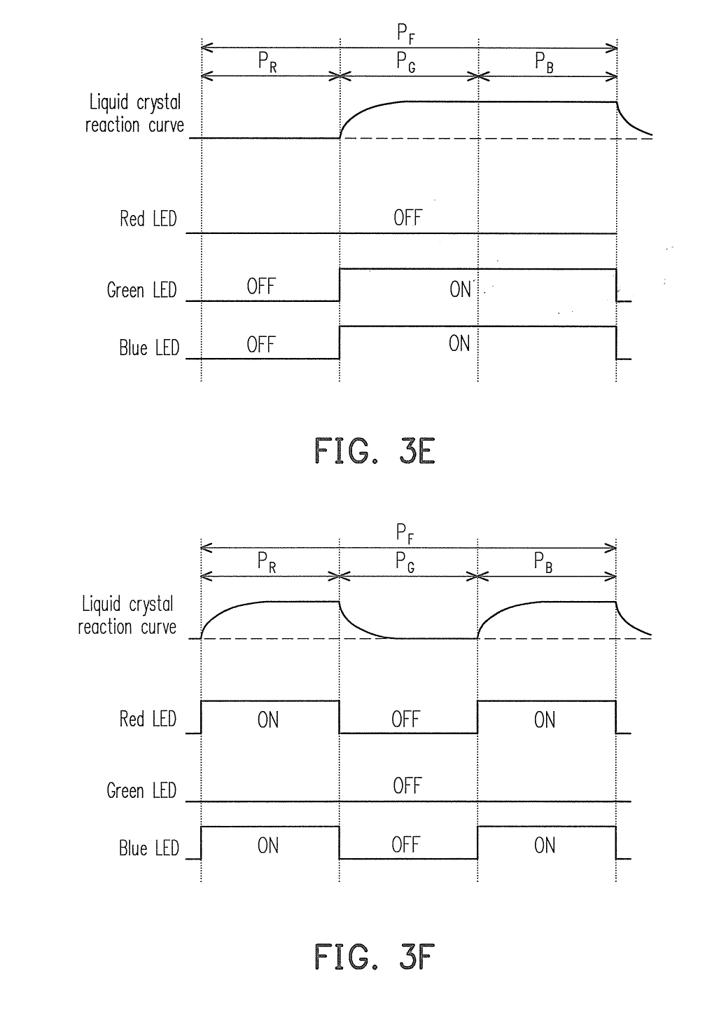

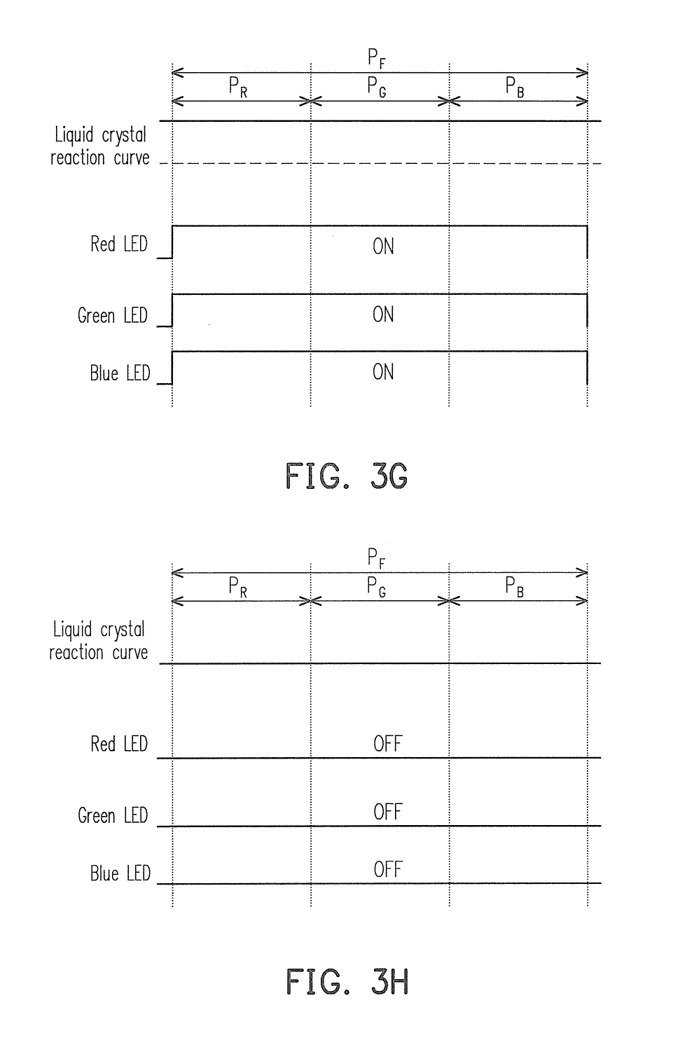

FIGS. 3A-3H are driving waveform diagrams of different pure color frames according to an exemplary embodiment of the invention. Referring to FIG. 2B and FIG. 3A, it is assumed that the frame period P_{F} includes a red color sub-frame period P_{R}, a green color sub-frame period P_{G} and a blue color sub-frame period P_{B}. The signal processing unit 211 generates the display data DS containing a red color sub-frame data, a green color sub-frame data and a blue color sub-frame data to the display panel 230 according to the video signal VS, wherein the display panel 230 respectively displays the red color sub-frame data, the green color sub-frame data and the blue color sub-frame data during the red color sub-frame period P_{R}, the green color sub-frame period P_{G} and the blue color sub-frame period P_{B}. If the video signal VS displays the frame data of a fully red color frame during the frame period P_{F}, the data analysing unit 213 can transmit the gray distributions of the three primary colors to the light source control unit 215 after analysing the video signal VS and/or the display data DS.

In the red color frame, there are little or none blue color and green color, so that the gray average values of the blue color and the green color are smaller than or equal to the threshold value, or the gray distribution ranges of the blue color and the green color fall within the threshold range. In other words, the gray average value of the red color is greater than the threshold value, or the gray distribution range of the red color exceeds the threshold range. Therefore, the light source control unit 215 turns off the blue light source corresponding to the blue color sub-frame period P_{B} and the green light source corresponding to the green color sub-frame period P_{G}, and only turns on the red light source corresponding to the red color sub-frame period P_{R}.

Moreover, a light emitting time of the red light source is greater than the corresponding red color sub-frame period P_{R}. In the present exemplary embodiment, the light emitting time of the red light source is equal to the whole frame period P_{F}. Now, the liquid crystals are correspondingly in a light transparent state, so that the red light can display a gray level of the image. Since the red light is continually provided during the frame period P_{F}, a usage rate of the red light source can be increased, so that a maximum brightness of the fully red color frame displayed by the liquid crystal panel 230 is increased.

Similarly, if the video signal VS displays the frame data of a fully green color frame during the frame period P_{F}, the light source control unit 215 controls the green light source of the light source module 220 to continually provide the green light during the frame period P_{F}, and turn off the red light source and the blue light source, and a driving waveform thereof is as that shown in FIG. 3B. If the video signal VS displays the frame data of a fully blue color frame during the frame period P_{F}, the light source control unit 215 controls the blue light source of the light source module 220 to continually provide the blue light during the frame period P_{F}, and turn off the red light source and the green light source, and a driving waveform thereof is as that shown in FIG. 3C.

On the other hand, the light emitting time of the red light source, the green light source and the blue light source is not limited to be equal to the frame period P_{F}, but can be smaller than the frame period P_{F}, though it is still greater than the corresponding color sub-frame period. Regarding other pure frames (for example, a yellow frame, a cyan frame and a magenta frame, etc.), the light source control unit 215 controls the light source module 220 to simultaneously turn on a plurality of color light sources in the red light source, the green light source and the blue light source. The light emitting time of the above red light source, the green light source and the blue light source is also equal to or smaller than the frame period P_{F}, though it is still greater than one of the red color sub-frame period P_{R}, the green color sub-frame period P_{G} and the blue color sub-frame period P_{B}.

Referring to FIG. 3D, if the video signal VS displays the frame data of a fully yellow color frame (i.e. a mixed color of red and green) during the frame period P_{F}, the light source control unit 215 controls the light source module 220 to turn off the blue light source during the frame period P_{F}, and turn on the red light source and the green light source. Wherein, the red light source and the green light source simultaneously emit light during the red color sub-frame period P_{R} and the green color sub-frame period P_{G}, i.e. the light emitting time of the red light source and the light emitting time of the green light source are the same, and the light emitting time of the red light source and the green light source is equal to a sum of the red color sub-frame period P_{R} and the green color sub-frame period P_{G}. Since the blue light source is turned off, the display panel 230 does not leak the blue light during the blue color sub-frame period P_{B}. Therefore, a color purity and a whole brightness of the yellow frame are increased.

Similarly, referring to FIG. 3E, if the video signal VS displays the frame data of a fully cyan color frame (i.e. a mixed color of green and blue) during the frame period P_{F}, the light source control unit 215 controls the light source module 220 to turn off the red light source during the frame period P_{F}, and turn on the green light source and the blue light source. Moreover, the green light source and the blue light source simultaneously emit light during the green color sub-frame period P_{G} and the blue color sub-frame period P_{B}.

Referring to FIG. 3F, if the video signal VS displays the frame data of a fully magenta color frame (i.e. a mixed color of red and blue) during the frame period P_{F}, the light source control unit 215 controls the light source module 220 to turn off the green light source during the frame period P_{F}, and turn on the red light source and the blue light source. Moreover, the red light source and the blue light source simultaneously emit light during the red color sub-frame period P_{R} and the blue color sub-frame period P_{B}. In some exemplary embodiments, besides the red color sub-frame period P_{R} and the blue color sub-frame period P_{B}, the red light source and the blue light source further emits light during the green color sub-frame period P_{G}, and the liquid crystal panel 230 also presents the light transparent state during the green color sub-frame period P_{G}.

Similarly, referring to FIG. 3G, if the video signal VS displays the frame data of a fully white color frame (i.e. a mixed color of red, green and blue) during the frame period P_{F}, the light source control unit 215 controls the light source module 220 to turn on the red light source, the green light source and the blue light source to simultaneously emit light during the frame period P_{F}. Referring to FIG. 3H, if the video signal VS displays the frame data of a fully black color frame during the frame period P_{F}, the light source control unit 215 controls the light source module 220 to turn off the red light source, the green light source and the blue light source during the frame period P_{F}, so that the red light source, the green light source and the blue light source cannot emit light during the frame period P_{F}.

According to the above descriptions, if the data analysing unit 213 receives a pure frame (for example, a pure red frame, a pure green frame, a pure blue frame, a pure yellow frame, a pure magenta frame, a pure cyan frame or a pure black frame) or a frame closed to a pure color, the data analysing unit 213 turns on all of or a portion of the red light source, the green light source and the blue light source through the light source control unit 215, and turns off the other color light sources. Moreover, during the color sub-frame period corresponding to the turned on color light source or during the frame period P_{F}, the turned on color light source may continually emit light. Since the light emitting time of each of the color light sources is increased, the maximum brightness of the pure color frame can be increased, and the color light sources that are not used can be turned off, so as to reduce a power consumption of the light source module 220.

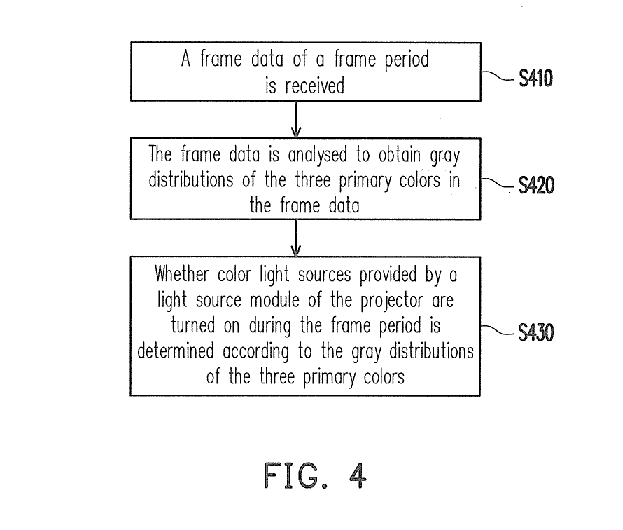

According to the above descriptions, a light source control method of a color sequential display is deduced below. FIG. 4 is a flowchart illustrating a light source control method of a color sequential display according to an exemplary embodiment of the invention. Referring to FIG. 4, first, a frame data of a frame period is received (step S410), wherein the frame period includes a plurality of color sub-frame periods (for example, the red color sub-frame period P_{R}, the green color sub-frame period P_{G} and the blue color sub-frame period P_{B}). Moreover, the frame data is analysed to obtain gray distributions of the three primary colors in the frame data (step S420). Then, whether all of or a portion of a plurality of color light sources provided by a light source module of the color sequential display are turned on during the frame period is determined according to the gray distributions of the three primary colors (step S430). Wherein, a light emitting time of the turned on color light source is longer than any one of the color sub-frame periods. Detailed steps can refer to the aforementioned descriptions, and detailed descriptions thereof are not repeated.

In summary, in the color sequential display and the light source control method thereof, according to the gray distributions of the three primary colors, when the obtained frame data is a pure color frame, the color light sources that are less used or not used are turned off, and the color light sources corresponding to the pure color frame are turned on. During a plurality of the color sub-frame periods or the whole frame period P_{F}, the turned on color light source continually emits light. By increasing the light emitting time of the color light source during the frame period P_{F}, a maximum brightness of the pure frame can be increased. A light leakage problem can be resolved by turning off the color light sources that are not used, so as to increase a color purity of the frame. Moreover, by turning of the color light sources that are not used, power consumption of the light source module can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light source control method of a color sequential display, comprising:
receiving a frame data of a frame period, wherein the frame period comprises a plurality of color sub-frame periods;
analysing the frame data to obtain gray distributions of a plurality of colors in the frame data; and
determining whether all of or a portion of a plurality of color light sources of the color sequential display are turned on during the frame period according to the gray distributions of the colors, wherein a light emitting time of the turned on color light source is longer than any one of the color sub-frame periods.

2. The light source control method of the color sequential display as claimed in claim 1, wherein the step of determining whether all of or a portion of a plurality of color light sources of the color sequential display are turned on during the frame period according to the gray distributions of the colors comprises:
when a gray average value of a first color of the colors is greater than a threshold value, turning on a first color light source corresponding to the first color in the color light sources; and
when the gray average value is smaller than or equal to the threshold value, turning off the first color light source.

3. The light source control method of the color sequential display as claimed in claim 1, wherein the step of determining whether all of or a portion of a plurality of color light sources of the color sequential display are turned on during the frame period according to the gray distributions of the colors comprises:
when a gray distribution range of a first color of the colors exceeds a threshold range, turning on a first color light source corresponding to the first color in the color light sources; and
when the gray distribution range of the first color falls within the threshold range, turning off the first color light source.

4. The light source control method of the color sequential display as claimed in claim 1, wherein when the turned on color light sources are plural, light emitting time of the turned on color light sources are the same.

5. The light source control method of the color sequential display as claimed in claim 1, wherein when the turned on color light sources are plural, light emitting time of the turned on color light sources are equal to a sum of all of or a portion of the color sub-frame periods.

6. The light source control method of the color sequential display as claimed in claim 1, wherein light emitting time of the turned on color light sources are equal to the frame period.

7. The light source control method of the color sequential display as claimed in claim 1, wherein the turned on color light sources simultaneously emit light.

8. A color sequential display, comprising:
a display panel;
a light source module, providing a plurality of color light sources to the display panel; and
a control module, receiving a frame data of a frame period, analysing the frame data to obtain gray distributions of a plurality of colors in the frame data, and determining whether or not to turn on all of or a portion the color light sources during the frame period according to the gray distributions of the colors, wherein the frame period comprises a plurality of color sub-frame periods, and a light emitting time of the turned on color light source is longer than any one of the color sub-frame periods.

9. The color sequential display as claimed in claim 8, wherein the control module comprises:
a signal processing unit, receiving the frame data, and generating a plurality of display data to the display panel according to the frame data;
a data analysing unit, receiving the frame data and the display data, and analysing the frame data and the display data to obtain the gray distributions of the colors as an analysing result; and
a light source control unit, receiving the analysing result to determine whether or not to turn on all of or a portion of the color light sources.

10. The color sequential display as claimed in claim 8, wherein when a gray average value of a first color of the colors is greater than a threshold value, the control module turns on a first color light source corresponding to the first color in the color light sources of the light source module, and when the gray average value is smaller than or equal to the threshold value, the control module turns off the first color light source of the light source module.

11. The color sequential display as claimed in claim 8, wherein when a gray distribution range of a first color of the colors exceeds a threshold range, the control module turns on a first color light source corresponding to the first color in the color light sources of the light source module, and when the gray distribution range of the first color falls within the threshold range, the control module turns off the first color light source of the light source module.

12. The color sequential display as claimed in claim 8, wherein when the turned on color light sources are plural, light emitting time of the turned on color light sources are the same.

13. The color sequential display as claimed in claim 8, wherein when the turned on color light sources are plural, light emitting time of the turned on color light sources are equal to a sum of all of or a portion of the color sub-frame periods.

14. The color sequential display as claimed in claim 8, wherein light emitting time of the turned on color light sources are equal to the frame period.

15. The color sequential display as claimed in claim 8, wherein the turned on color light sources simultaneously emit light.
